(19) United States
(12) Patent Application Publication
(10) Pub. No.: US 2007/0031009 A1
(43) Pub. Date: Feb. 8, 2007

(54) Method and system for string-based biometric authentication

(76) Inventor: Julius Mwale, New York, NY (US)

Correspondence Address: BAY AREA INTELLECTUAL PROPERTY GROUP, LLC, PO BOX 210459, SAN FRANCISCO, CA, 94121-0459, US

(21) Appl. No.: 11/401,833

(22) Filed: Apr. 11, 2006

Related U.S. Application Data
(60) Provisional application No. 60/671,870, filed on Apr. 15, 2005.

(51) Int. Cl. G06K 9/00

(52) U.S. Cl. 382/115; 340/5.52; 713/182

(57) ABSTRACT

Techniques for string-based biometric authentication are described that includes a method for string-based biometric authentication provided that comprises the steps of receiving a username and password combination associated within a person, acquiring a biometric data from the person, generating a random string of biometric information based on the biometric data using a randomization function, truncating said random biometric string, and storing said truncated random biometric string along within the associated username and password combination of the person in a biometric database for future authorizations of the same person. To authenticate a user, the acquired biometric data is compared with a truncated biometric string in said biometric database searching for a match, and if a match is found, authorization of the person to access a resource is given.

### CROSS-REFERENCE TO RELATED APPLICATIONS

The present Utility patent application claims priority benefit of the U.S. provisional application for patent No. 60/671870 filed on Apr. 15, 2005 under 35 U.S.C. 119(e).

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### FIELD OF THE INVENTION

The present invention relates generally to biometric authentication systems. More particularly, the invention relates to biometric authentication systems that use a unique truncated string representation of a biometric to authenticate an authorized user.

### BACKGROUND OF THE INVENTION

The increase in online banking fraud is a concern for consumers and banks. Identity theft and password hacking are increasing everyday. Consumers need software, which is more secure and provides them with a capability to protect the privacy of their data. Access to a protected resource should only be granted to the legitimate and authorized user.

Other known attempts have been made to make banking systems more secure by using biometric technology. However, their applications are typically limited to storing full fingerprint (e.g., without limitation, a fingerprint) images, or templates, or using tokens. Token-based approaches do not store the fingerprint, and may cause multiple resulting problems. Such problems include the increased amount of space taken in database storage, network security, and concerns that consumers have about their fingerprint being stored in a database. As a result, a solution for a single problem leads to even more problems, so a viable solution to online banking fraud must still be taken into account.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flow chart showing a conventional banking system;

FIG. 2 illustrates an example of the fingerprint I/P and authentication (TA) step of the present invention being inserted into the conventional authentication system of FIG. 1, in accordance with an embodiment of the present invention;

FIG. 3 illustrates exemplary detailed steps for fingerprint I/P and authentication (TA), in accordance with an embodiment of tie present invention;

FIG. 4 illustrates, by way of an example and not limitation, how a fingerprint authentication system may augment a conventional authentication system, in accordance with an embodiment of the present invention;

FIG. 5a and 5b illustrate the top-level flow of events during the authentication process, in accordance with an embodiment of the present invention;

FIGS. 6a and 6b illustrate, by way of example and not limitation, the names of exemplary code modules that contain the software code to implement an embodiment of the present invention;

FIG. 7 illustrates the inheritance between the different classes of FIG. 6 and how they relate and come together, in accordance with an embodiment of the present invention;

FIG. 8 illustrates some exemplary classes that are generated in a possible implementation, in accordance with an embodiment of the present invention; and

FIG. 9 illustrates an exemplary computer system that, when appropriately configured or designed, may serve as a computer system in which the authentication system may be implemented, in accordance with an embodiment of the present invention.

### Unless otherwise indicated illustrations in the figures are not necessarily drawn to scale.

### SUMMARY OF THE INVENTION

To achieve the forgoing and other objects and in accordance with the purpose of the invention, a variety of techniques for string-based biometric authentication are described.

In an embodiment a method for string-based biometric authentication provided that comprises the steps of receiving a username and password combination associated with a person, acquiring a biometric data from the person, if it is the first time authenticating the person, generating a random string of biometric information based on the biometric data using a randomization function, truncating said random biometric string, and storing said truncated random biometric string along with the associated username and password combination of the person in a biometric database for future authorizations of the same person; however, if it is not the first time authenticating the person, comparing the acquired biometric data within a truncated biometric string in said biometric database searching for a match, and it a match is found, communicating an authorization of the person to access a resource.

A system, means for, steps for, computer software product, and computer readable medium are also provided, embodiments of which are adapted to enable and/or achieve the foregoing functionality.

Other features, advantages, and object of tie present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

The present invention will be described in detail with reference to an embodiment thereof as illustrated in the accompanying, drawings. While embodiments of the invention are discussed below with reference to the figures, those skilled in the art will readily appreciate that the detailed description given herein with respect to these figures is for explanatory purposes as the invention extends beyond these embodiments.

One aspect of the invention is to implement biometric technology in an innovative way that addresses the lack of security in online systems (e.g., banking), as well as practicality issues related to the use of biometric. The preferred embodiment of the present invention uses biometric authentication as an additional layer of security, without replacing or interfering with conventional authentication schemes. Moreover, the described embodiment leverages the fact that a fingerprint scan is fast, reliable, convenient, and relatively affordable.

An aspect of the present embodiment is that the randomly generated string that is later truncated and stored in the database has no direct relationship to the use's fingerprint image or template, which has at least two attendant aspects. One is that the user's fingerprint is not transmitted over the network. It is, instead, converted into a string, and the second is that any unauthorized access to the database will not result in any loss of a user's log in data. Another aspect of the present embodiment is that a randomly generated string is stored in the database and not a fingerprint image or template. This resolves issues with database storage, networks security and objections to use of biometric like storing of fingerprint data. A string of data does not take much room in a database, and no hacker or identity thief will be able to put the string to use as they can do now with account password based security systems.

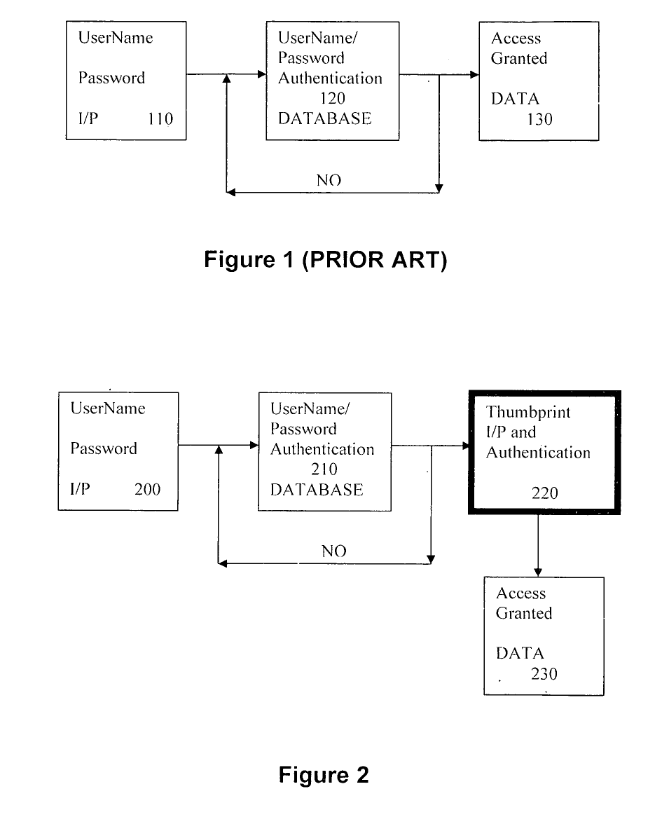

FIG. 1 illustrates a low chart showing a conventional banking system. Conventional banking system 100 incorporates a user name 110, known as User ID, which is the identity of the consumer, and a password 110, which is the authorization key for the particular user. The conventional banking system 100 requires only the two data inputs: user name and password. Upon verification of the user name and password 120, the user is granted access 130 to the protected resource. FIG. 1 clearly displays how simple it is for one to gain access into an account and gain total control over it before they are recognized and finally blocked.

FIG. 2 illustrates an example of the fingerprint I/P and authentication (TA) method of the present invention being inserted into the conventional authentication system of FIG. 1, in accordance with an embodiment of the present invention. In the present embodiment after a user is authorized by way of the fingerprint identification method, he or she will be allowed access to the protected resource, for example without limitation, gaining access into an online banking system. Fingerprint authentication, step 220, is used to authenticate the ID of the user after the username and password have been verified at step 210. If the username and password are incorrect as entered at step 210, then the user is prompted to reenter the username and password. If the username and password are correct at step 210, the system moves on to step 220 where the user's fingerprint data is acquired and authenticated. It should be appreciated that the system which executes part or all of the fingerprint data acquisition and/or authentication may be remotely located (e.g., without limitation, on a server over a network, the Internet, an Intranet, telephone lines, wireless means, etc.) from the location where any of the other Steps are performed. It is contemplated that those skilled in the art will readily recognize, in light of the teachings of the present invention, that the present algorithm may be suitably adapted for utility in a wide variety of alternative configurations. For example, without limitation, some alternative system configurations include users and computers authentication in a windows based intranet system for authentication on central server, door protection and attendance logging, and desktop protection as a standalone application.

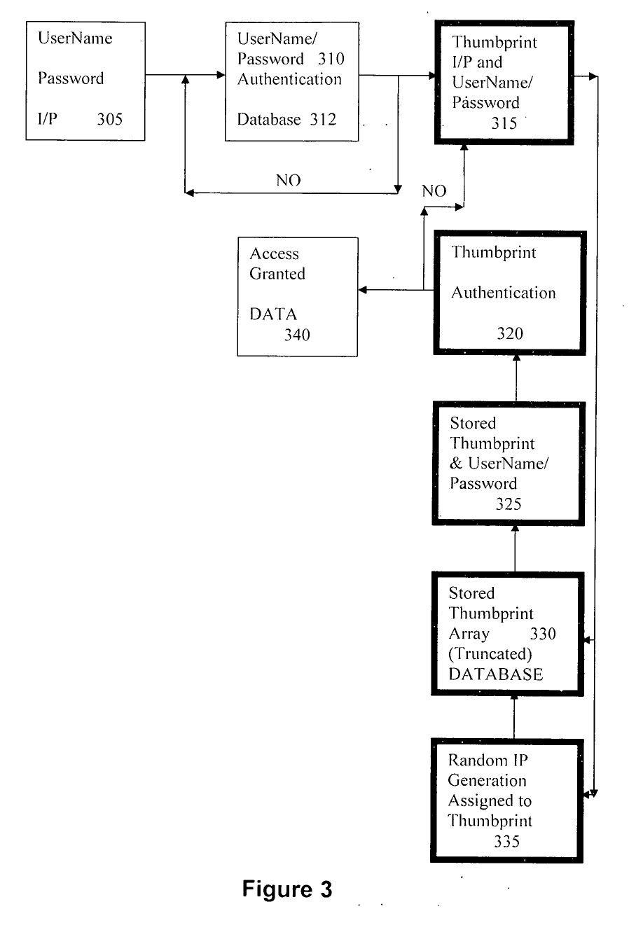

FIG. 3 illustrates exemplary detailed steps for fingerprint I/P and authentication (TA), in accordance with an embodiment of the present invention. In the present embodiment, the process is initiated by a user request for access. The user requests access by entering a username and password at step 305. The username and password is then authenticated at step 310 by comparing the username and password with the username and password stored in a username and password database. If the username and password are authenticated in step 312, the system proceeds to the fingerprint I/P and authentication (TA) starting with step 315 as detailed below.

In the present embodiment, once a user is authenticated using the conventional authentication system shown in FIG. 1, the user is prompted to enter a fingerprint on a conventional fingerprint device/console at step 315 and the fingerprint is processed. By way of example and not limitation, a common type of fingerprint device/console may be one that is plugged into a computer's USB port/console incorporated into the system. In the present embodiment, if the user is authenticating for the first time using the system, the system goes to step 335 where it generates a random string of fingerprint information. A Random string is generated based on fingerprint data using a randomization function. The randomization may be achieved using any suitable technique known to those in the art; however, the current embodiment uses an RSA encryption since RSA is a widely accepted algorithm for encryption and generates random strings of varying lengths based on the usage. A random string is generally more secure and difficult to understand compared to directly mapped strings or strings generated using simple techniques. Those skilled in the art, in light of the teachings of the present invention, will readily recognize a multiplicity of alternative and suitable techniques to generate a fingerprint string representation based on the fingerprint information.

In subsequent authentication of the same user, the system will, instead, proceed from step 315 to step 330 where the user will be authenticated with a stored truncated string in the database. The stored truncated string will be compared with the one generated when the user tries to authenticate in step 315. For a new user, the random string from step 335 is truncated in step 330. In the present embodiment, truncating a string increases the complexity of the string and makes it even harder to understand and decode the string. One aspect of this approach is that it offers the benefits of storing less data per string and it is more complex. In the generation of the truncated data string in step 330, the data string is preferable shortened by 1 digit of information before it is authenticated and access is granted. Truncation, in the present embodiment, is performed using compression algorithm where it is guaranteed that the truncated string will contain at least 1 digit less compared to original string. An example of the truncation process is described in more detail below. In the present embodiment, after the fingerprint data string has been created and stored in steps 335 and 330, the system continues on to step 325 where the truncated data string is stored in a fingerprint database that also stores the user's username and password data for subsequent authorizations of the same user. The user is then authenticated in step 320 by comparing the data input by the user, username, password and fingerprint, with the data stored in the fingerprint database. If the data is verified as matching the data stored in the fingerprint database, the system proceeds to step 340 where the user is granted access to the protected resource. If the username, password or fingerprint data does not match the stored data, the system returns to step 312 or step 315 and the user is requested to reenter the username, password or fingerprint.

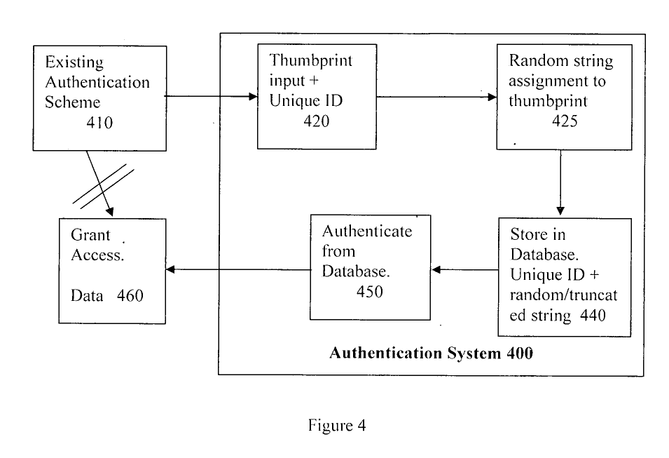

FIG. 4 illustrates, by way of an example and not limitation, an exemplary fingerprint authentication method that augments a conventional authentication system, in accordance with an embodiment of the present invention. It will be shown how the augmentation of the present authentication method provides more security than a conventional system alone. The method shown comprises a conventional/existing authentication module 410 that authenticates a username with a password. However, instead of a direct path to an access granting module 460, where access is conventionally granted to the user (the skipped path being represented by a double barred arrow) the present embodiment provides additional security means to authenticate the user, thus adding another layer of security to conventional/existing authentication system 410.

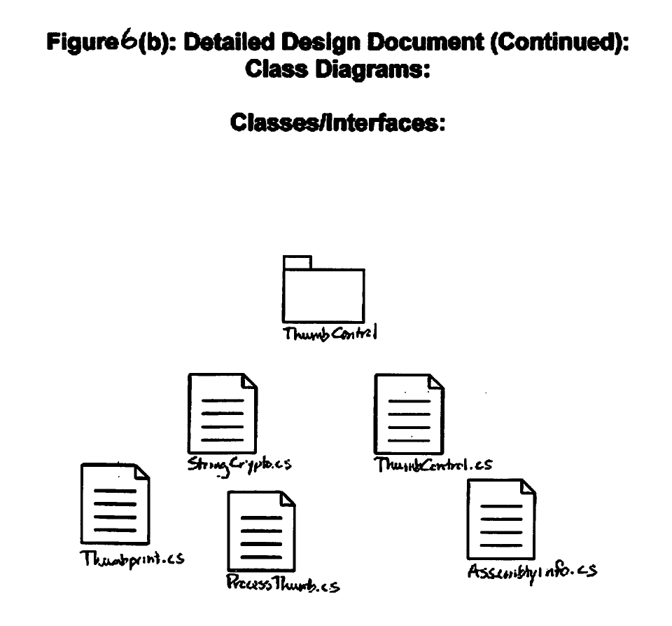

As shown in the Figure, an authentication system 400, according to an embodiment of the present invention. Some implementation details will be further described below in connection with FIG. 6. The present process begins with the user's fingerprint being entered into a Fingerprint acquisition module 420. A unique ID is generated by conventional authentication scheme 410 and is transmitted to the present authentication system to uniquely identify a particular user. The user may be prompted to enter their fingerprint using a fingerprint device/console, for example without limitation, one that plugs into a computer's USB port or is incorporated in the particular electronic device, and the fingerprint is scanned and provided to the present authentication system. A randomization module 425 assigns a random string to the user's fingerprint, and communicates the random fingerprint string to a truncation module 440 that stores the truncated fingerprint string along with its corresponding unique ID in a fingerprint database (not shown). In the present embodiment, the randomly generated string has an identifying relationship between the user and the fingerprint. However, in some alternative embodiments of the present invention, the unique ID may be provided by any conventional means or, in yet other embodiments, not be used at all; for example, without limitation, in some applications it may not be required to positively and uniquely identify an individual (i.e., with a unique ID), but instead to determine if the fingerprint is part of an authorized class of users to access a particular resource (e.g., without limitation administrators to a secure system). An authentication module authenticates the user's fingerprint from the database.

In the present embodiment, authentication module 450 acts differently for an existing user than it does for a new user. In the case of an existing user, the user will be authenticated against the random string stored in the database with the one that will be entered at the time of authentication. After successful authentication, authentication module 450 communicates an authentication signal to access granting module 460, which grants the user access to the protected resource. However, if the user is accessing the system for the first time, the random string will be stored in the database, the user will be enrolled, and finally the user will granted access to the data by access granting module 460. Those skilled in the art, in light of the teachings of the present invention, will readily recognize a multiplicity of alternative and suitable applications, steps and/or systems configurations to implement some or all of the novel aspects of the present embodiment.

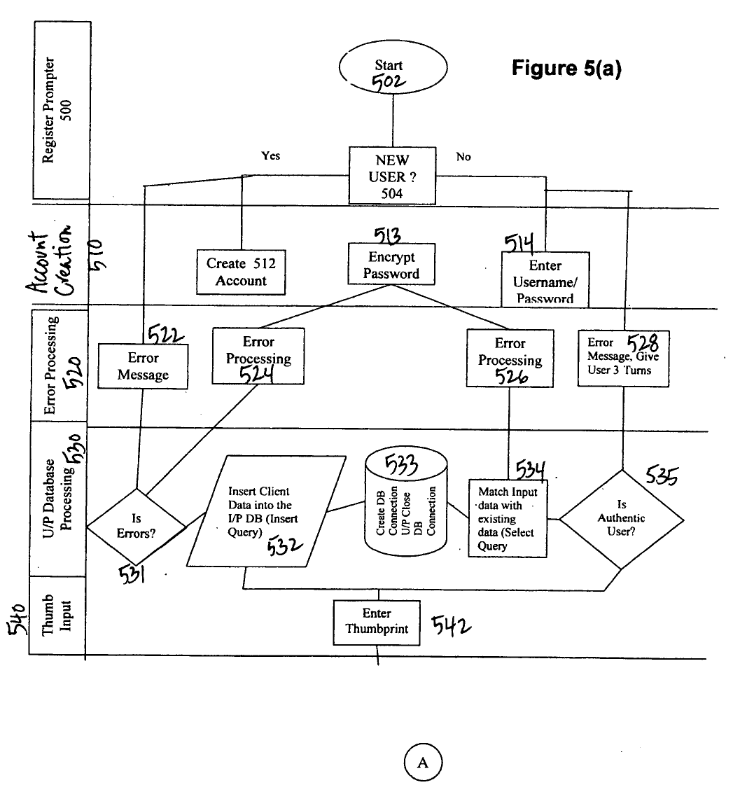

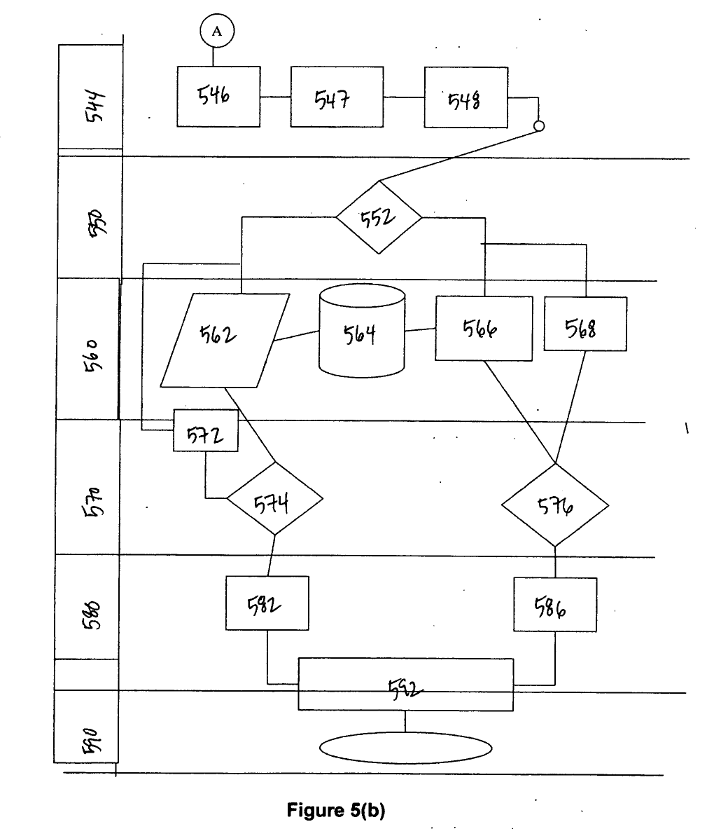

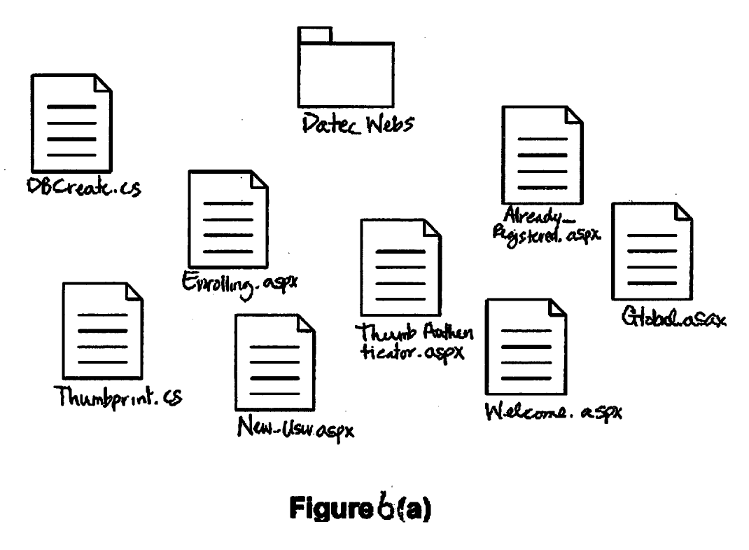

FIGS. 5a and 5b illustrate by way of example the top-level flow of events during the authentication process, in accordance with an embodiment of the present invention. In the present embodiment, a registration prompter stage 500 is used to decide whether the person is a new user or an existing user. At start 502, the user will identify if the user is a new user or an existing user at step 504. An account creation and authentication stage 510 will process both new users and existing users. If the user is new, then an account begins to be created at step 512 as opposed to an existing user, which is, instead, prompted to enter the existing user's username and password at step 514 for authentication. At an error processing stage 520, the validity of the username and password is determined. It is contemplated that in some practical authentication system embodiments, all passwords are encrypted using standard encryption techniques recognized and accepted by authoring bodies governing the internet space. For passwords, there are certain conventional guidelines, like a minimum number of characters, at least one number etc. Any violation of these will result in appropriate error message to be displayed to user and asking user to correct it. If the username or password are not valid, the user will receive an error message at step 528. By way of example and not limitation, an existing user may be allowed three opportunities at step 528 to correctly enter a valid username and password. Some embodiments may allow more or less opportunities to enter a valid username and password. In the present embodiment, at a username/password database processing stage 530, an account is either created at step 532 to match new information, or a user is authenticated at step 535. To authenticate for an existing user, the inputted data is compared and matched in the database with existing data 534. If a new account is created for a new user, then the new user client data is entered into the username/password database at step 532. Typically, before entering data into database, structures like a database table need to be created in database to hold the data in the proper format. Once this is done, a database connection is established and the data is entered in the correct format. The connection to the database is typically closed after this to maintain the integrity and consistency of the database systems. Those skilled in the art, however, may design alternative approaches based on the foregoing teaches that best suit the particular application.

In any case, whether the user is new or existing, a fingerprint is scanned and entered at step 542 into the system at a fingerprint input stage 540. For clarity, it Should be noted that circle A at the top of FIG. 5b indicates the continuation from the previous figure, FIG. 5a. During thumb processing stage 544, a fingerprint image is turned into a data string at step 546. A unique random number is then generated at step 547. Then, the randomly generated number is truncated at step 548. At a user classification stage 550, it is determined whether a user is new or existing at step 552. At a fingerprint/user ID/password (T/U/P) database processing stage 560, if the user is new, data about the fingerprint, username, and password are stored in the database at step 562. However, if the user already has an account, i.e., an existing user, the existing user's fingerprint is searched for and matched in the database that holds stored information for fingerprint authentication. In the present embodiment, the system creates a database connection at step 564. In the present embodiment, the existing user is authenticated with the stored fingerprint string in the database with the one that is generated when the user tries to authenticate. By way of example, and not limitation, some embodiments may utilize typical fraud prevention measures such as, but not limited to, allowing an existing user a limited number of times to correctly scan their fingerprint before it is matched; otherwise, the user is blocked from access to the protected resource. Step 568 shows that the user is given 3 attempts to correctly scan their fingerprint, but any number of scans may be allowed. In the present embodiment, at the fingerprint authentication stage 570 for a new user, it is determined whether a thumb was inserted in the device correctly at step 574. If the thumb was inserted incorrectly, the new user is sent back to step 572 and receives an error message. For an existing user at stage 570, the fingerprint data is checked to determine if the fingerprint is authentic at step 576. At the permission granting stage 580, an account is created for a new user at step 582. For an existing user, at step 586 the account is verified and access to data is granted. During the control handover stage 590, control is handed over to the client's platform at step 592 for integration processes. Those skilled in the art, in light of the teachings of the present invention, will readily recognize a multiplicity of alternative and suitable schemes to implement some or all of the novel aspects of the present embodiment possibly in conjunction with conventional security schemes to satisfy the needs of the particular application

FIGS. 6a and 6b illustrate, by way of example and not limitation, the names of exemplary code modules that contain the software code to implement an embodiment of the present invention. The classes are self-explanatory to those skilled in the art and the code maintains modularity and structure of tile foregoing system and method embodiments. In the present embodiment, the “DBCreate” class handles all the activities related to database like creating table, inserting and selecting data from table. It also establishes connection with database server. The “ProcessThumb” class processes the input fingerprint and verifies for a match between the fingerprint string from database and the user input fingerprint string.

By way of example, and not limitation, referring to both FIGS. 3 and 6a, in one embodiment of the present invention, the fingerprint (TP) acquisition, processing, and storage algorithm (e.g., Steps 315 through 340) might be implemented as a software subroutine, defined in pseudo-code as follows:

Input: User fingerprint input

Output: Stored String in database

100 Start

110 Get the fingerprint features as input data; and define as TP(i). (From a fingerprint acquisition device).

120 Convert the fingerprint into a string; defined as TP(s).

130 Apply a random algorithm (e.g., Random on TP(s)) with an output of TP(r).

140 Apply a truncation Algorithm (Truncate on TP(r)) with an output of TP(t).

150 Store TP(t) the Finger-print Database.

160 Stop.

By way of further example, and not limitation, referring again both FIGS. 4 and 6a, in all embodiment of the present invention, to get string from database and match it with the input fingerprint (e.g., Step 450) might be implemented as a software subroutine, defined in pseudo-code as follows:

Input: Stored Fingerprint string in database

Output: Fingerprint matching Success or Failure result

200 Start

210 Get finger-print string TP(t) from fingerprint database.

220 Apply a truncation reversal algorithm Truncaterev on TP(t)) to restore TP(r).

230 Apply a randomization reversal algorithm Randomrev on TP(r) to restore TP(s).

240 Convert the fingerprint string TP(s) into fingerprint features TP(i).

250 Get the fingerprint features TP(n) as new input from the user to be authenticated.

260 Match TP(i) with TP(n) using a vendor specific matching algorithm.

270 Display Success/Failure based on the threshold for matching.

Stop.

In the present embodiment, the “Fingerprint” class contains the unique ID and fingerprint properties. Also, “StringCrypto” is used for encryption and decryption of string data.

By way of further example and not limitation, the foregoing randomization algorithm might be implemented as a software subroutine, defined in pseudo-code as follows:

Algorithm Random ( )

Input: string TP(s)

Output: string TP(r)

300 Start

310 Divide the input TP(s) into strings of equal length, the last string being smaller than other strings. These strings are now in the format S(i). In the present embodiment the division of TP(s) is performed base on the implementation of encoding format. Unicode encoding, each string preferably cannot exceed 58 chars, while for other encodings, this limit is 116 chars.

320 For each S(i) in Tp(s) repeat:

325 Encrypt S(i) to get S(r) using RSA with public Key P (pub-k).

330 End For loop.

340 Combine All S(r) together to make TP(r).

350 Return TP(r).

360 Stop.

It should be appreciated that the encryption used may based on other standard encryption algorithms depending upon the needs of the particular application. Currently, however, RSA offers the maximum redundancy in data. Randomization is preferably implemented by suitably dividing the data and performing RSA on individual pieces of data.

By way of further example, and not limitation, the foregoing randomization reversal algorithm might be implemented as a software subroutine, defined in pseudo-code as follows:

Randomrev ( )

Input: string TP(r)

Output: string TP(s)

400 Start

410 Divide the input TP(r) into strings S(i) of equal length. The last string will also be of equal length as the other strings.

420 For each S(i) in Tp(r) repeat

430 Decrypt S(i) to get S(s) using RSA encryption with private Key P (pri-k).

440 End For loop.

450 Combine All S(s) together to make TP(s).

460 Return TP(S).

470 Stop.

This class may be used to provide additional encryption and decryption features used by the application and may be used across the present authentication system to implement the security in the application.

By way of further example, and not limitation, the foregoing truncation algorithm might be implemented as a software subroutine, defined in pseudo-code as follows:

Truncate( )

Input: string TP(r)

Output: string TP(t)

500 Start

510 Get input TP(r).

520 Compress using existing algorithm to generate TP(t).

530 Return TP(t).

540 Stop

By way of further example, and not limitation, the foregoing truncation reversal algorithm might be implemented as a software subroutine, defined in pseudo-code as follows:

Trucaterev ( )

Input: string TP(t)

Output: string TP(r)

600 Start

610 Get input TP(t)

620 Decompress using same algorithm as in Truncate ( ) to generate TP(r).

630 Return TP(r)

640 Stop

By way of further example, and not limitation, the method to derive the randomized truncated string may be implemented as a series of mathematical transforms as follows. In the following example, the input fingerprint feature is tp(i) in a string/byte format. The process begins by applying transformation T on tp(i): Tp=T[tp (i)]. Then the Algorithm Random ( ) is applied on tp(s): Tp(r)=R[tp(s)], followed by the application of the Algorithm Truncate ( ) on tp(r): tp(t)=Tr[tp(r)]—where T is a transformation from byte/string to string format, R is the randomization function, and Tr is the Truncation function. Also T′, R′, Tr′ are the inverse transformations for T, R, Tr respectively.

By way of further example, and not limitation, the randomization function R, where tp(s) is passed as an input P (i.e., R[input]) may be implemented as a series of mathematical procedures as follows:

700 Differentiate the input as F (p)=d/d(x) (P) to produce P₀, P₁, P₂ . . . , Pₙ, where x=0 . . . n;

710 Apply RSA to P₀, P₁, P₂ . . . , Pₙ, where x=0 . . . n:
F (p)=RSA(P_{0, P}₁, P₂ . . . , Pₙ); where x=0 . . . n;
F (p)=RSA(P₀)+RSA (P₁)+RSA(P₂)+ . . . +RSA(Pₙ); where x=0 . . . n; (RSA will be described in more detail below)

The result produced is:

720 F(r)=R₀+R₁+R₂+ . . . +Rₙ; where x=0 . . . n;

Summing all the terms F(r)=ΣRᵢ; where i=0 . . . n;

In the present embodiment, the randomization is not necessarily just a matter of performing RSA, but comprises dividing, the data into different pieces and applying RSA on these individual pieces of data. When these RSA applied data are collected together again, a random string is obtained. This complete process is referred to as randomization and a randomization function is presently termed for this.

730 Integrate the terms against a standard derivative, with result of:
tp(r)=(x=0, x=n)∫ R(x) dx; tp(r) now represents the random string.

740 Apply Tr on tp(r) to get F(t):
F(t)=Tr[tp(r)];
Substituting for tp(r)
F(t)=Tr [(x=0, x=n)∫ R(x) dx];
F(t)=C (R0)+C(R1)+C(R2)+ . . . C(Rn); where x=0 . . . n, and C is the compression transformation. Compression techniques are a well known in the computer arts to compress data to reduce space requirements and for maintaining high performance over networks by supplying transmitting less bits of data.
F(t)=ΣC(Ri); where i=0 . . . n;

740 tp(t)=(x=0, x=n)∫C(R(x)) dx; where tp (t) is the randomized truncated string, which is stored in database.

750 Applying the inverse Transformations for Tr, R and T in reverse order as follows:
Applying transformation Tr′ on tp (t)−tp(r)=Tr′[tp(t)];
Applying transformation R′ on tp(r)−tp(s)=R [tp(r)];
Applying transformation T′ on tp(s)−tp(i)=T [tp(s)];
Where tp(i) is the Final string/byte data to be matched.

A more detailed description of RSA (Input, key) follows. In the present embodiment, if the key is public, it encrypts the input, otherwise it decrypts the input.

By way of example, and not limitation, the foregoing RSA public key encryption algorithm might be implemented as a software subroutine, defined in pseudo-code as follows:

800 Find P and Q, two large (e.g., 1024-bit) prime numbers.

810 Choose E such that E is greater than 1, E is less than PQ, and E and (P−1) (Q−1) are relatively prime, which means they have no prime factors in common. E does not have to be prime, but it must be odd. (P−1)(Q−1) can't be prime because it's an even number.

820 Compute D such that (DE−1) is evenly divisible by (P−1)(Q−1). Mathematicians write this as DE=1 (mod (P−1)(Q−1)), and they call D the multiplicative inverse of E. This is well known to those skilled in the art; for example, one could simply find an integer X which causes D=(X (P−1)(Q−1)+1)/E to be an integer, and then use that value of D.

830 Encrypt according to the encryption function C=(TˆE) mod PQ, where C is the ciphertext (a positive integer), T is the plaintext (a positive integer), and ˆindicates exponentiation. The message being encrypted, T must be less than the modulus, PQ.

840 Decrypt according to the decryption function T=(CˆD) mod PQ, where C is the ciphertext (a positive integer), T is the plaintext (a positive integer), and ˆindicates exponentiation.

The public key is the pair (PQ, E). The private key is the number D , and should be kept secret. The product PQ is the modulus, often called N in the literature. E is the public exponent. D is the secret exponent. In the present embodiment. “ThumbControl” includes all the functionality related to device connection, taking fingerprint input from user and error handling for the device. The “Already Registered” class handles the functions related to a user who is already registered with the system. It also authenticates the user with the database. The “New User” class handles the functionality related to a new user using tile system. It also inserts a record for the user into the system. In the present embodiment, the Jagrsa.cs class (not shown) class contains the public interface for the methods that implement the truncation and detruncating of the string, which is randomized, by the methods in Jagcompress. The CryptoGraphy.cs class (not shown) implements the core functioning of the truncation and encryption features of the system. The class uses 128 bit key encryption and the complete data is truncated and encrypted with the methods provided by this class. The Jagcompress.cs class (not shown) provides the features of randomizing the fingerprint input and converting it into a random string that contains garbage data and the data has no relevance with the actual fingerprint. It also implements the reverse procedure for the string to fingerprint conversion. Those skilled in the art, in light of the teachings of the present invention, will readily recognize a multiplicity of alternative and suitable encryption/decryption or reversible string security techniques depending upon the needs of the particular application.

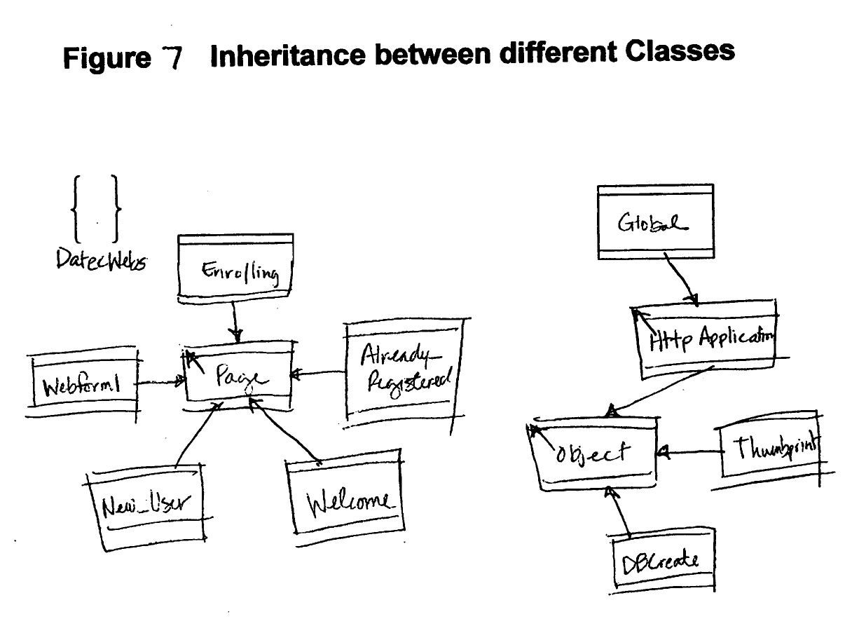

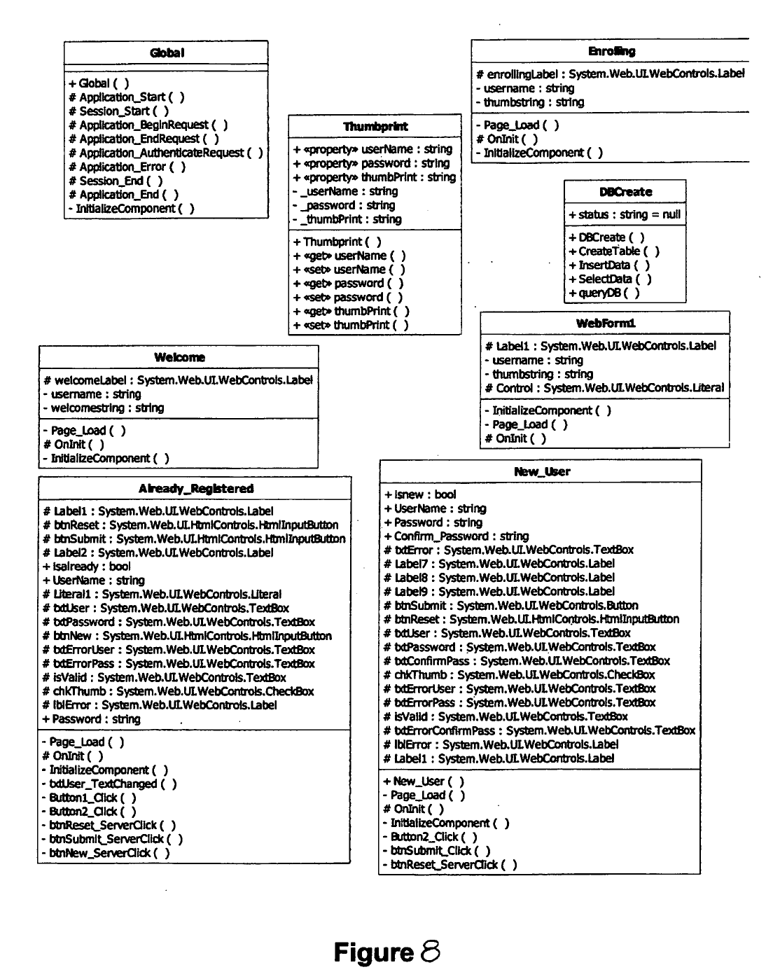

FIG. 7 illustrates the inheritance between the different classes of FIG. 6 and how they relate and come together, in accordance with an embodiment of the present invention. The Figure shows the functioning and the relation of these classes and the way they interact with each other to complete the system. For example, without limitation, a page is the main class from where other pages are derived. An enrolling page is made for a new user and when the new user successfully logs in, they are directed to welcome page. This inheritance is a feature of the underlying development platform and language.

FIG. 8 illustrates some exemplary classes that are generated in a possible implementation, in accordance with an embodiment of the present invention. Shown in the Figure is a sample class containing properties and methods which are used by the same class or other classes to derive the functionality. For example, without limitation, a thumbprint class contains username, password and thumbprint as its properties which can be set and get using its methods. Similarly, a page class contains buttons, text boxes etc. and methods to perform activity based on the input.

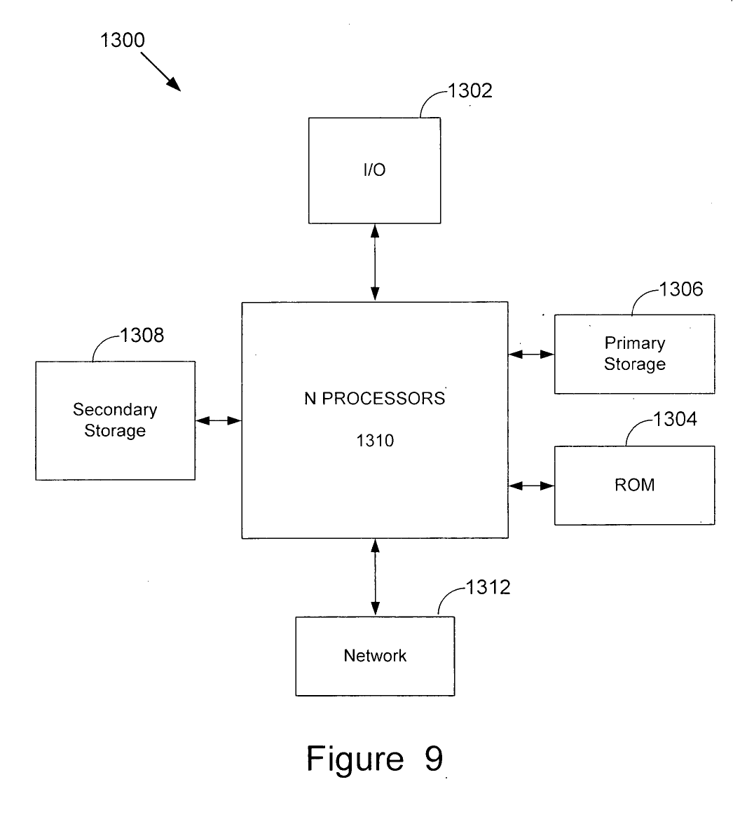

FIG. 9 illustrates an exemplary computer system that, when appropriately configured or designed, may serve as a computer system in which the authentication system may be implemented, in accordance with an embodiment of the present invention. A computer system 1300 comprises any number of processors 1310, also referred to as central processing units, or CPUs. CPU 1310 may be coupled to storage devices including primary storage 1306, typically a random access memory, or RAM and primary storage 1304, typically a read only memory, or ROM. CPU 1310 may be of various types of microcontrollers and microprocessors such as, but not limited to, programmable devices, for example without limitation, CPLDs and FPGAs and unprogrammable devices such as, but not limited to, gate array ASICs or general purpose microprocessors. As is well known in the art, primary storage 1304 acts to transfer data and instructions uni-directionally to CPU 1310 and primary storage 1306 is used typically to transfer data and instructions in a bi-directional manner. Both of these primary storage devices may include any suitable computer-readable media such as those described above. In the present embodiment, a mass storage device 1308 may also be coupled bi-directionally to CPU 1310 and provides additional data storage capacity and may include any of the computer-readable media described above. Mass storage device 1308 may be used to store programs, data and the like and is typically a secondary storage medium such as a hard disk. It is appreciated that the information retained within the mass storage device 1308, may, in appropriate cases, be incorporated in standard fashion as part of primary storage 1306 as virtual memory. In the present embodiment, a specific mass storage device such as a CD-ROM may also pass data uni-directionally to the CPU.

In the present embodiment, CPU 1310 may also be coupled to an interface 1302 that connects to one or more input/output devices such as such as but not limited to video monitors track balls, mice, keyboards, microphones, touch-sensitive displays, transducer card readers, magnetic or paper tape readers, tablets, styluses, voice or handwriting recognizers. Finally, CPU 1310 optionally may be coupled to an external device such as, but not limited to, a database or a computer or telecommunications or internet network using an external connection as shown generally at 1312. With such a connection, it is contemplated that the CPU might receive information from the network, or might output information to the network in the course of performing the method steps described herein.

In view of the forgoing teachings, it is clear the implementations of the present invention will secure commerce and financial transactions/resources well beyond that of conventional authentication systems. Another aspect of the present invention is that it enables individuals who want control of their finances and or business themselves to not rely on an independent contracting team to set up a biometric authenticating system for them, as is currently required by conventional methods. In this way, Enterprises, businesses, and individuals gain more freedom and control because they are the main decision makers of their activities.

Those skilled in the art will readily recognize how to implement the coding of the present invention in light of the foregoing teachings. By way of example, and not limitation, the software code may be written using Microsoft Visual Studio.Net in C# and ASP.NET. It may also be coded to property execute on IIS 6.0 and above and modern web browsers (e.g., Internet Explorer 6.0 and above). A suitable databases, for example without limitation, is Microsoft SQL Server, Oracle, and IBM DB2.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemlented using any of a wide variety of suitable processes and system modules, and is not limited to any particular computer hardware, software, firmware, microcode and the like.

Having fully described at least one embodiment of the present invention, other equivalent or alternative methods of implementing, string-based fingerprint authentication technique according to the present invention is apparent to those skilled in the art. For example, although the particular implementation of the string-based authentication techniques described in the foregoing were directed to fingerprint implementation it is contemplated that similar techniques are applicable to any biometric identification information (where a fingerprint is just one kind) capable of being parameterized into a parametric string such as, without limitation, retinal scans, voice prints, palm recognition, vein and blood flow recognition systems, hand geometry, and facial features, wherein such implementation of the present invention are all contemplated as within the scope of the present invention. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A method for string-based biometric authentication, the method comprising the Steps of:
receiving a username and password combination associated with a person;
acquiring a biometric data from the person;
if it is the first time authenticating, the person, generating a random string of biometric information based on the biometric data using a randomization function, truncating said random biometric string, and storing said truncated random biometric string along within the associated username and password combination of the person in a biometric database for future authorizations of the same person;
if it is not the first time authenticating the person, comparing the acquired biometric data within a truncated biometric string in said biometric database searching for a match; and
if a match is found, communicating an authorization of the person to access a resource.

2. The method for string-based biometric authentication of claim 1, in which said randomization function is based on an RSA encryption algorithm.

3. The method for string-based biometric authentication of claim 2, in which said RSA encryption algorithm is a software subroutine that comprises Steps for implementing RSA public key encryption algorithm.

4. The method for string-based biometric authentication of claim 1, in which said biometric data is a fingerprint.

5. The method for string-based biometric authentication of claim 1, in which said biometric data is based on one or more of a retinal scan, a voice print, a palm print, a vein or blood flow pattern, a hand geometry pattern, and/or a facial feature patter.

6. The method for string-based biometric authentication of claim 1, in which said step of truncating comprises the step of shortening said random biometric string by 1 digit of information.

7. The method for string-based biometric authentication of claim 1, in which said truncating step comprises Steps for truncating said random fingerprint string.

8. The method for string-based biometric authentication of claim 1, in which said random string generating step comprises Steps for generating a random fingerprint string.

9. The method for string-based biometric authentication of claim 1, in which the Steps of generating said truncated, random string is calculated as a series of mathematical transforms comprising the Steps of:
applying transformation T on tp (i): Tp=[tp(i)], where tp(i) is an input biometric data feature in a string/byte format;
applying a random algorithm R on tp(s): Tp(r)=R[tp(s)];
applying a truncate algorithm on tp(r): tp (t)=Tr[tp(r)], where T is a transformation from byte/string to string format, and Tr is a Truncation function.

10. The method for string-based biometric authentication of claim 9, in which the randomization function R to produce a random string is implemented as a series of mathematical procedures as follows:
a. Differentiate the input as F(p)=d/d(x)(P) to produce P₀, P₁, P₂ . . . , Pₙ, where x=0 . . . n;
b. F(p)=RSA (P₀, P₁, P₂ . . . , Pₙ,); where x=0 . . . n, and RSA is a RSA public key encryption algorithm;
c. F(p)=RSA(P0)+RSA(P1)+RSA(P2)+ . . . + RSA(Pn); where x=0 . . n;
d. F(r)=ΣRi=R₀+R₁+R₂+ . . . + Rₙ; where x=0 . . . n, and i=0 . . . n;
e. tp(r)=(x=0, x=n)∫ R(x) dx, whereby tp(r) represents the random string;
f. F(t)=Tr [tp(r)];
g. F(t)=Tr [(x=0, x=n)∫ R(x) dx];
h. F(t)=ΣC (Ri)=C(R₀)+C(R₁)+C(R₂)+ . . . C(Rₙ), where x=0 . . . n, i=0 . . . n, and C is a compression transformation
i. tp(t)=(x=0, x=n)∫ C(R(x)) dx, where tp(t) is a randomized truncated string stored in said database;
j. tp(r)=Tr′[tp(t)], where Tr′ is the inverse transformation Tr;
k. tp(s)=R′[tp(r)], where R′ is the inverse transformation of R;
l. tp(i)=T [tp(s)]; where T′ is the inverse transformation of T, and tp(i) is the final string/byte data to be matched;

11. A system for string-based biometric authentication, the system comprising:
mean for receiving a username and password combination associated with a person;
mean for acquiring a biometric data from the person;
mean for generating a random string of biometric information based on the biometric data;
mean for truncating said random biometric string:
mean for storing said truncated random biometric string along with the associated username and password combination of the person in a biometric database for future authorizations of the same person;
mean for comparing the acquired biometric data within a truncated biometric string in said biometric database searching for a match; and
mean for communicating an authorization of the person to access a resource if a match is found.

12. A method for string-based biometric authentication, the method comprising:
Steps for receiving a username and password combination associated with a person;
Steps for acquiring biometric data from the person;
if it is the first time authenticating the person, Steps for generating a random string of biometric information based on the biometric data using a randomization function, Steps for truncating said random biometric string, and storing said truncated random biometric string along with the associated username and password combination of the person in a biometric database for future authorizations of the same person;
if it is not the first time authenticating the person, Steps for comparing the acquired biometric data with a truncated biometric string in said biometric database searching for a match; and
if a match is found, communicating an authorization of the person to access a resource.

13. A computer readable medium storing computer executable components for string-based biometric authentication, comprising:
a component that receives biometric data a username and password all associated with a person;
a component that generates a random string of biometric information based on the biometric data;
a component that truncates said random biometric string;
a component that stores said truncated biometric string along with the associated username and password combination of the person in a biometric database for future authorizations of the same person;
a component that compares the acquired biometric data with a truncated biometric string in said biometric database to find a match; and
a component that communicates an authorization of the person to access a resource if a match is found.

14. The computer readable medium of claim 13, in which said biometric data is a fingerprint.

15. A computer program product residing on or being distributed across one or more computer readable mediums having a plurality of instructions stored thereon which, when executed by one or more associated processors, cause the one or more processors to:
receive a username and password combination associated with a person;
acquire a biometric data from the person;
if it is the first time authenticating the person, generate a random string of biometric information based on the biometric data using a randomization function;
truncate said random biometric string, and store said truncated random biometric string along with the associated username and password combination of the person in a biometric database for future authorizations of the same person;
if it is not the first time authenticate the person, compare the acquired biometric data with a truncated biometric string in said biometric database searching for a match; and
if a match is found, communicate an authorization of the person to access a resource.

16. The computer program product according to claim 15, wherein the computer-readable medium is one selected from the group consisting of a data signal embodied in a carrier wave, an optical disk, a hard disk, a floppy disk, a tape drive, a flash memory, and semiconductor memory.

17. The computer program product according to claim 15, in which said biometric data is a fingerprint.

18. The computer program product according to claim 15, in which said randomization function is based on an RSA encryption algorithm.

19. The computer program product according to claim 15, in which said truncation comprises shortening said random biometric string by 1 digit of information.

20. The computer program product according to claim 15, in which said biometric data is based on one or more of a retinal scan, a voice print, a palm print, a vein or blood flow pattern, a hand geometry pattern, and/or a facial feature pattern.
